(19) United States
(12) Patent Application Publication
(10) Pub. No.: US 2023/0331474 A1
(43) Pub. Date: Oct. 19, 2023

(54) WEARABLE REFUSE COLLECTION RECEPTACLE

(71) Applicant: Operation Litter Ridder Inc., Woodbridge (CA)

(72) Inventor: Kathryn Elizabeth LEINSTER, Woodbridge (CA)

(21) Appl. No.: 18/299,405

(22) Filed: Apr. 12, 2023

(30) Foreign Application Priority Data
Apr. 14, 2022 (CA) 3155408

(51) Int. Cl. B65F 1/14; B65F 1/00; B65F 1/04; B65F 1/16; A45F 3/04

(52) U.S. Cl. CPC B65F 1/1468; B65F 1/002; B65F 1/04; B65F 1/1623; B65F 1/1646; A45F 3/04; B65F 2220/106

(57) ABSTRACT

A wearable litter receptacle comprises a container defining an interior volume and having a litter-receiving opening that opens into the interior volume, shoulder straps coupled to the container whereby the receptacle can be worn as a backpack, and a lid, wherein the lid is hinged to the container adjacent the shoulder straps so that the lid can pivot between an open position in which the opening of the container is exposed, and a closed position in which the lid covers the opening. At least one pull is coupled to the lid and adapted to move the lid from the closed position to the open position by pulling upon the pull. When the container is worn by a user with the lid in the open position, the lid forms a shield to protect the back of the user's head.

### CROSS-REFERENCE TO RELATED APPLICATIONS

This application claims priority under 35 U.S.C. § 119 to Canadian Patent Application No. 3,155,408 filed Apr. 14, 2022, which issued as Canadian Patent No. 3,155,408 on Mar. 7, 2023; the disclosure of which is incorporated herein by reference in its entirety.

### TECHNICAL FIELD

The present invention relates to refuse collection, and more particularly to a wearable refuse collection receptacle.

### BACKGROUND

Wearable litter collection bags are known in the art. These frequently take the form of an open topped bag that is carried at the hip and supported by a cross-strap that extends over the opposite shoulder. These are somewhat awkward, result in an unbalanced load and are ergonomically unsuited to be carried for relatively long periods of time.

### SUMMARY

In one aspect, a wearable litter receptacle comprises a container defining an interior volume and having a litter-receiving opening that opens into the interior volume, shoulder straps coupled to the container whereby the receptacle can be worn as a backpack, a lid, wherein the lid is hinged to the container adjacent the shoulder straps so that the lid can pivot between an open position in which the opening of the container is exposed and a closed position in which the lid covers the opening. When the container is worn by a user with the lid in the open position, the lid forms a shield to protect a back of the user's head from refuse directed toward the opening of the container. At least one pull is coupled to the lid and adapted to move the lid from the closed position to the open position by pulling upon the pull.

Preferably, when the container is worn by a user with the lid in the open position, the lid forms a shield to protect a back of the user's head.

In some embodiments, the container may be a rigid container or may be a soft-walled, collapsible container; in the latter case a substantially rigid frame may extend around and maintain the opening.

In some embodiments, the wearable litter receptacle may further comprise a removable liner, which may be a washable, reusable liner, or may be a disposable liner.

In some embodiments, the wearable litter receptacle may further comprise at least one fastener adapted to couple the respective pull to at least one of the shoulder straps to maintain the lid in the open position.

In some embodiments, there are two pulls in a chevron-shaped arrangement.

Each pull may be of adjustable length.

In some embodiments, the lid may be hinged to the container by a living hinge.

In some embodiments, the lid may be substantially rigid. In other embodiments, the lid may be a soft-walled lid whose shape is maintained by a substantially rigid support.

### BRIEF DESCRIPTION OF THE DRAWINGS

These and other features will become more apparent from the following description in which reference is made to the appended drawings wherein:

FIG. 1 is a top perspective view of a wearable refuse collection receptacle, shown in a closed configuration;

FIG. 2 is a first side elevation view of the wearable refuse collection receptacle of FIG. 1, shown in the closed configuration;

FIG. 3 is a front elevation view of the wearable refuse collection receptacle of FIG. 1, shown in the closed configuration;

FIG. 4 is a second side elevation view of the wearable refuse collection receptacle of FIG. 1, shown in the closed configuration;

FIG. 5 is a rear elevation view of the wearable refuse collection receptacle of FIG. 1, shown in the closed configuration;

FIG. 6 is a top plan view of the wearable refuse collection receptacle of FIG. 1, shown in the closed configuration;

FIG. 7 is a bottom plan view of the wearable refuse collection receptacle of FIG. 1, shown in the closed configuration;

FIG. 8 is a top perspective view of a portion of the wearable refuse collection receptacle of FIG. 1, shown in an open configuration;

FIG. 9 is a first side elevation view of a portion of the wearable refuse collection receptacle of FIG. 1, shown in the open configuration;

FIG. 10 is a rear elevation view of a portion of the wearable refuse collection receptacle of FIG. 1, shown in the open configuration;

FIG. 11 is an exploded top perspective view of a portion of the wearable refuse collection receptacle of FIG. 1, shown in an open configuration and illustrating removal of a removable liner;

FIG. 12 is a top perspective view of the removable liner of FIG. 11 showing reinforcement of a mouth of the removable liner;

FIG. 13 is a side elevation view showing the wearable refuse collection receptacle of FIG. 1 as worn by a human individual, shown in the closed configuration; and

FIG. 14 is a side elevation view showing the wearable refuse collection receptacle of FIG. 1 as worn by the human individual, shown in the open configuration.

### DETAILED DESCRIPTION

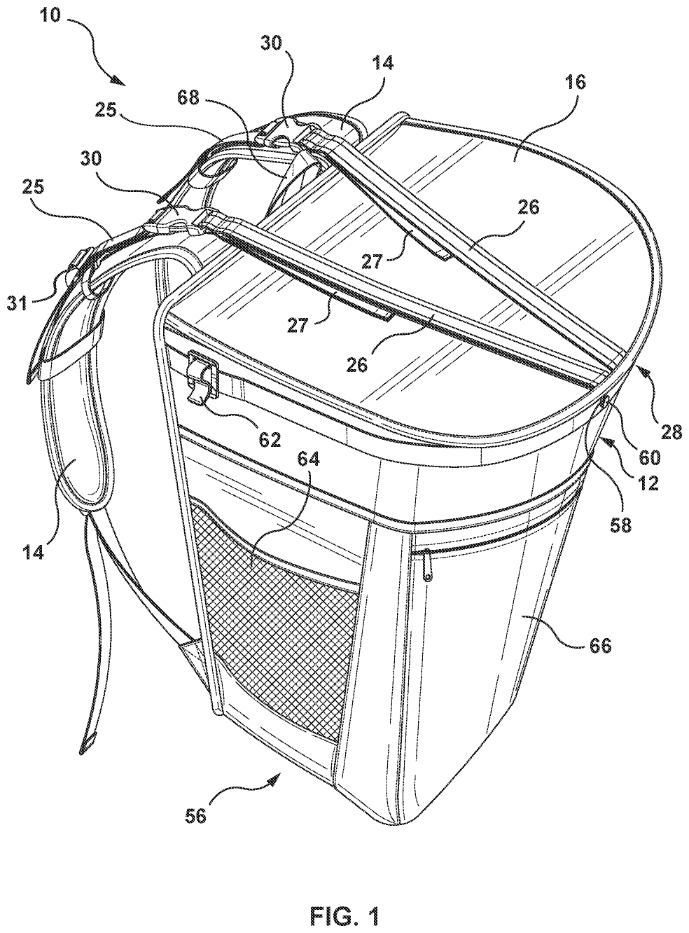

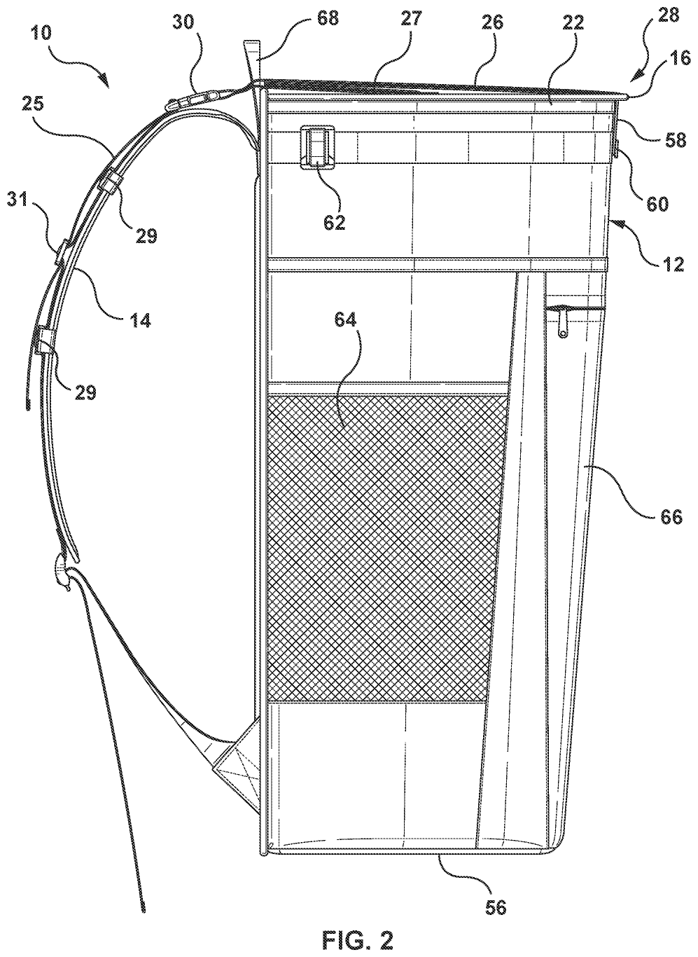

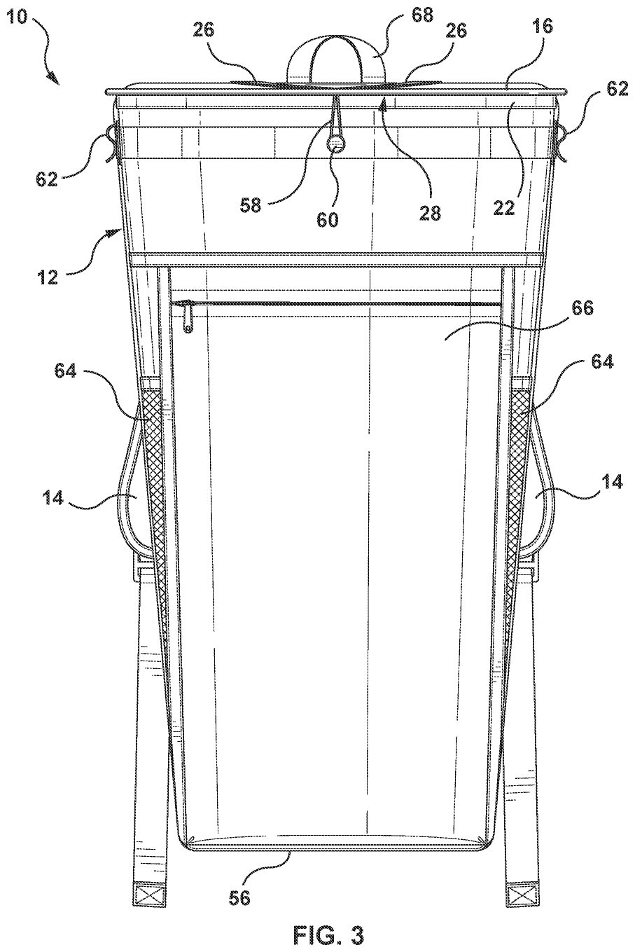

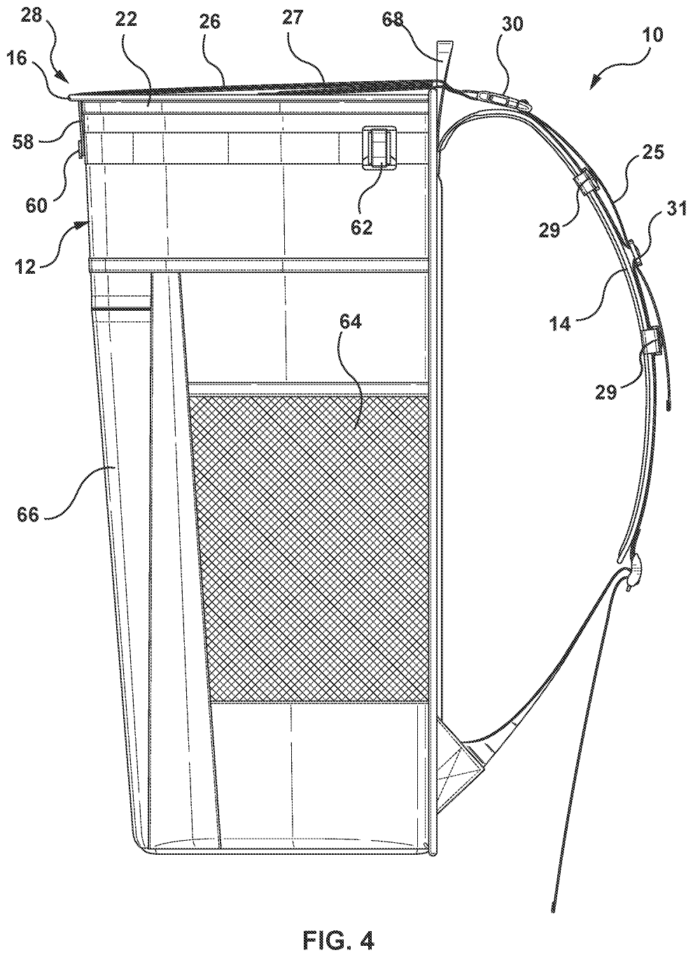

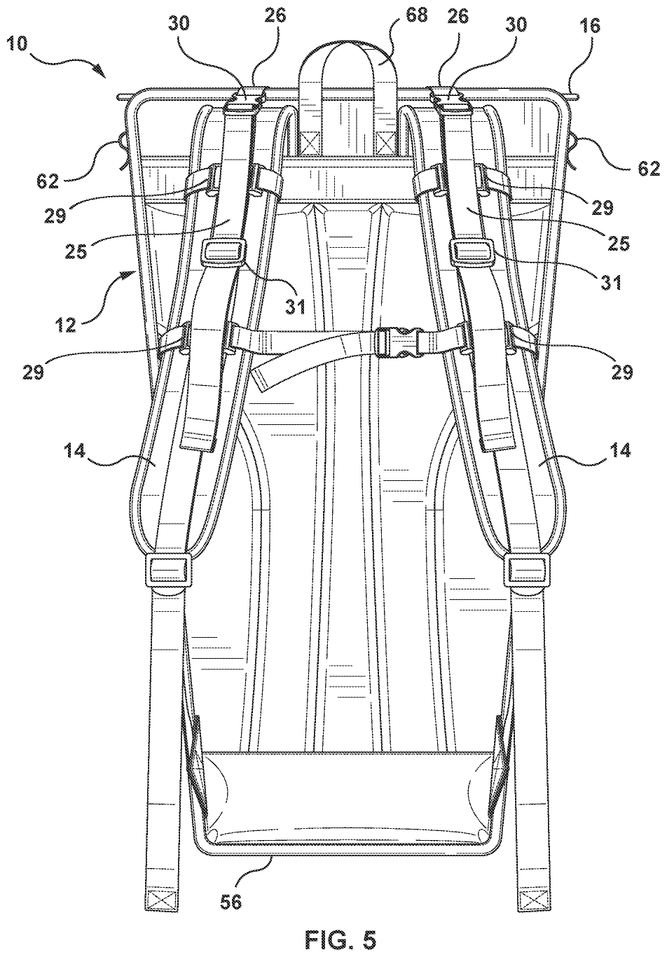

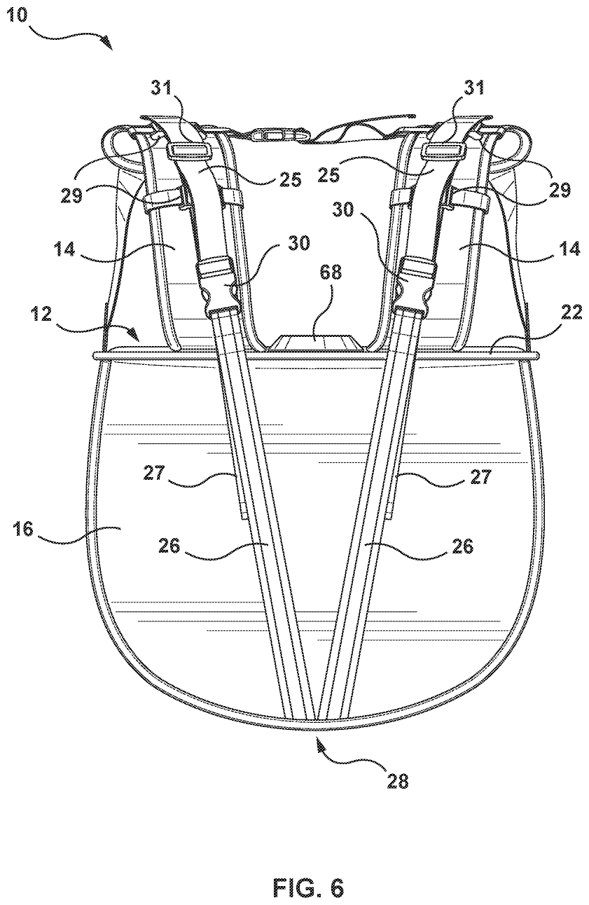

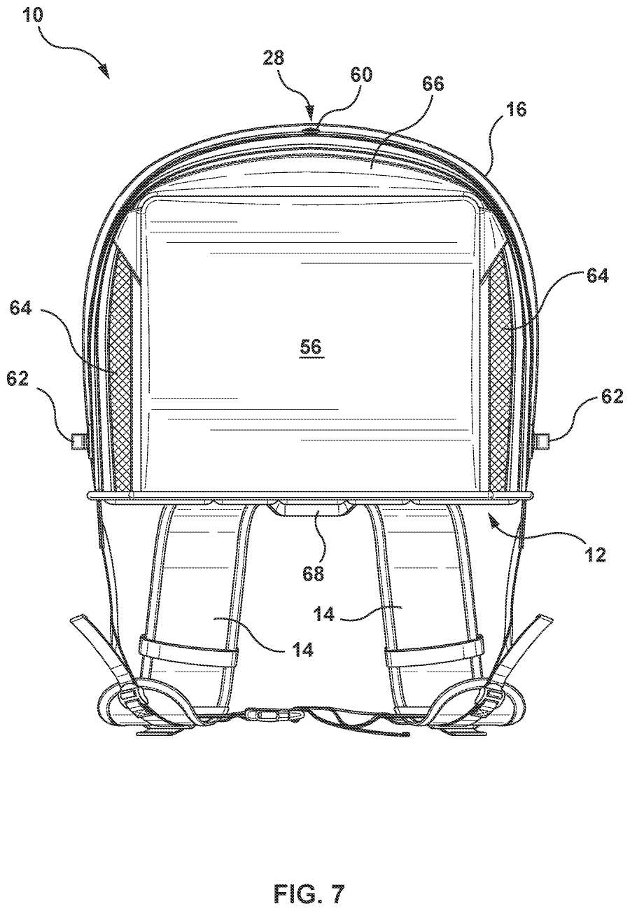

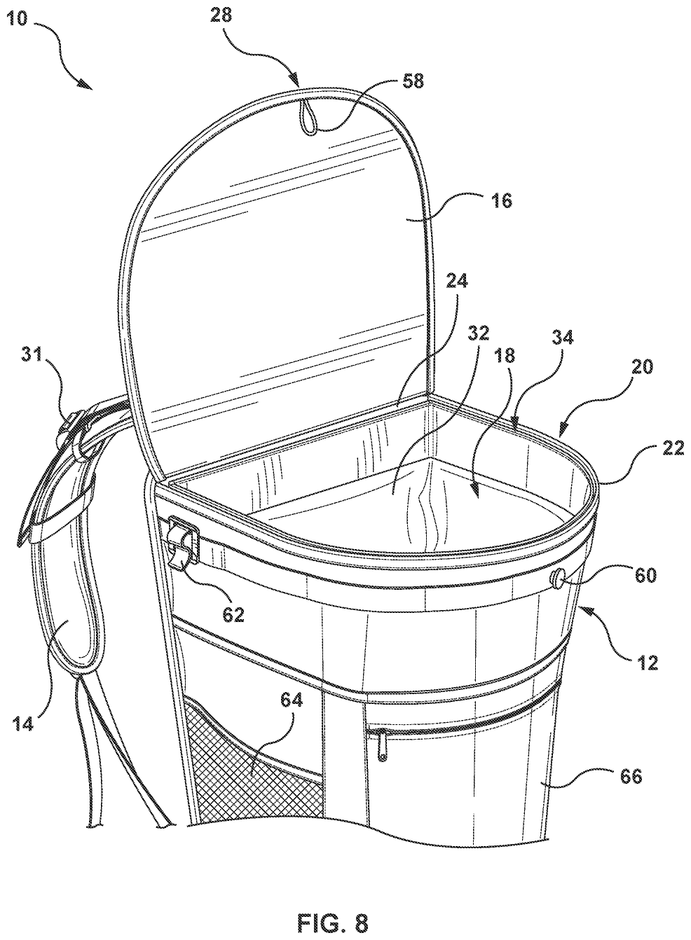

Reference is now made to FIGS. 1 through 10, in which one illustrative embodiment of a wearable litter receptacle is indicated generally at reference 10. The wearable litter receptacle 10 comprises a container 12, shoulder straps 14 coupled to the container 12, and a lid 16. The container 12 defines an interior volume 18 (see FIG. 8) and has a litter-receiving opening 20 (see FIG. 8) that opens into the interior volume 18. The lid 16 is hinged to the container 12 adjacent the shoulder straps 14 so that the lid 16 can pivot between an open position (FIGS. 8 to 10) in which the opening 20 of the container 12 is exposed, and a closed position (FIGS. 1 to 7) in which the lid 16 covers the opening 20. Thus, the wearable litter receptacle 10 has an open configuration (FIGS. 8 to 10) wherein the lid 16 is in the open position, and a closed configuration (FIGS. 1 to 7) wherein the lid 16 is in the closed position. The lid 16 is preferably at least substantially coextensive with the opening 20, although in some embodiments the lid 16 may be larger than the opening 20.

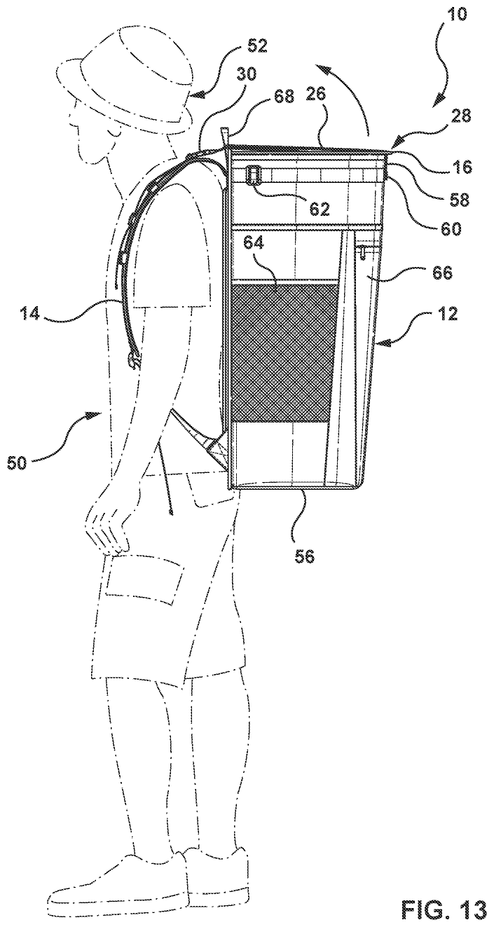

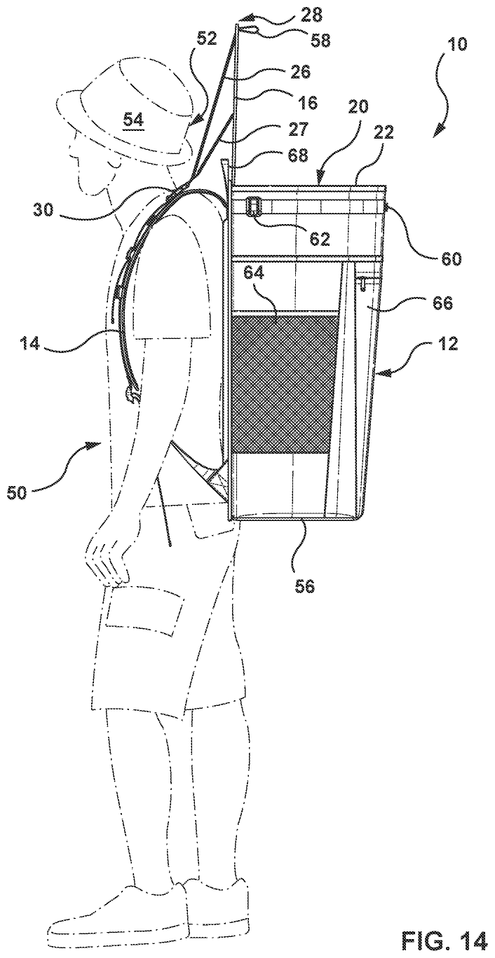

Referring now to FIGS. 13 and 14, the shoulder straps 14 are coupled to the container 12 in such a way that the wearable litter receptacle 10 can be worn as a backpack by a user 50, with the lid 16 and opening 20 oriented upward. The shoulder straps 14 are preferably adjustable to accommodate persons of various shapes and sizes, may be made of any suitable material(s), and may have other features known in the art for backpack shoulder straps, including padding, ventilation surfaces, cross-straps, and the like. The shoulder straps 14 shown in the drawings are merely illustrative and are not intended to be limiting.

In some embodiments, the container 12 may be a rigid container; in preferred embodiments the container 12 is a soft-walled, collapsible container 12. In such cases, the container 12 may be formed from any suitable material(s), including natural fabrics, synthetic fabrics, blends of natural and synthetic fabrics, or plastic sheet materials, or any combination thereof. Where the container 12 is a soft-walled, collapsible container 12, a substantially rigid frame 22 extends around and maintains the opening 20 so that the opening 20 does not collapse. The frame 22 may be formed, for example, from plastic, metal, rolled fabric ribbing of sufficient rigidity, or a combination thereof. Preferably the container 12 is formed from a washable material, such as machine-washable fabric(s) or plastic materials that can be cleaned with soap and water. Optionally, the container 12 can be releasably coupled to the shoulder straps 14 so that the shoulder straps 14 can be removed to facilitate washing of the container 12 and/or shoulder straps 14 separately from one another.

The lid 16 is preferably substantially rigid, or alternatively the lid 16 may be a soft-walled lid whose shape is maintained by a substantially rigid support, for example a support formed from plastic, metal or rolled fabric ribbing. In a preferred embodiment, the lid 16 is hinged to the container by a living hinge 24. For example, where the container 12 is a soft-walled, collapsible container 12, the living hinge 24 may be made of the same material as that of the container 12. Other types of hinging arrangements are also contemplated. Optionally, the lid 16 may be releasably hinged to the container 12, for example by hook-and-loop fasteners, magnets, snap fasteners, buckles or other suitable fasteners. In such embodiments, the lid 16 may be released from the container 12 for cleaning and then recoupled to the container 12.

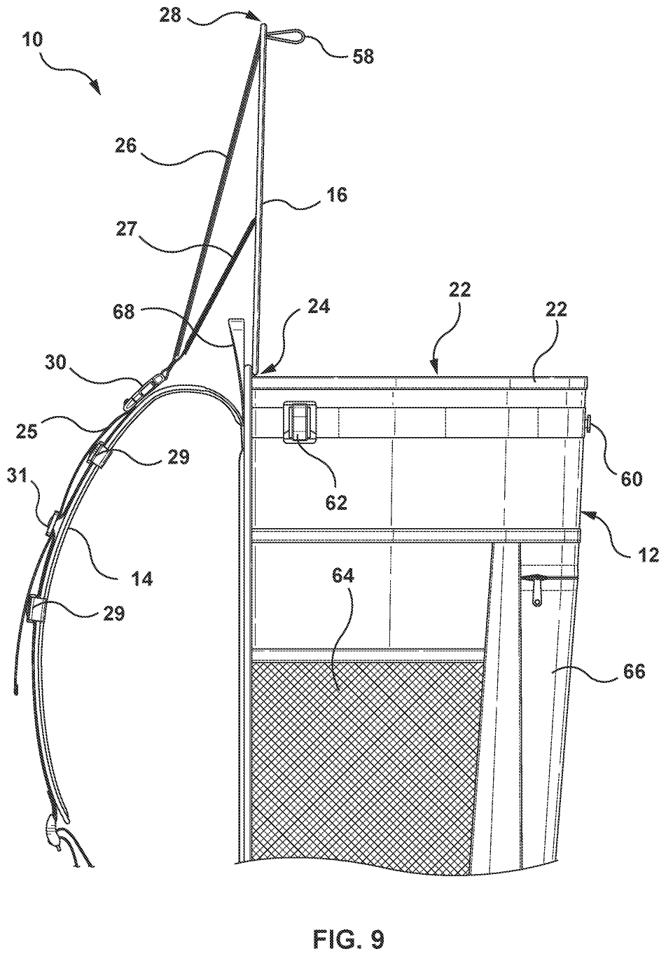

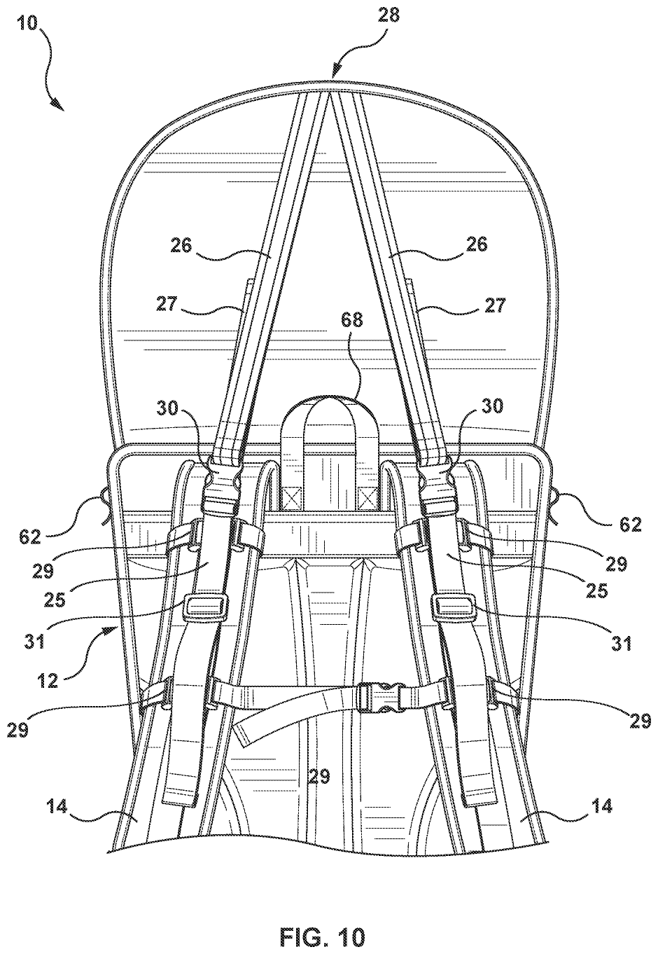

To facilitate moving the lid 16 between the open position and the closed position, two pulls 26 are coupled to the lid 16 and adapted to move the lid 16 from the closed position to the open position by pulling upon the pulls 26. In the illustrated embodiment, the pulls 26 are secured at a distal end 28 of the lid 16, that is, the end of the lid 16 opposite where the lid 16 is hinged to the container 12, and are disposed in a chevron-shaped arrangement wherein the pulls 26 diverge such that each of the pulls 26 is approximately in registration with a respective one of the shoulder straps 14. The pulls 26 can be coupled to their respective shoulder straps 14 to maintain the lid 16 in the open position, as best seen in FIG. 9 and also shown in FIG. 10. In the illustrated embodiment, each of the pulls 26 carries one portion of a quick-release clip buckle 30 and each of the shoulder straps carries the other portion of the clip buckle 30. In the illustrated embodiment, the clip buckles 30 are not directly attached to the shoulder straps 14; the portion of each clip buckle 30 not carried by the pull 26 is coupled to a pull strap 25 which is in turn secured to the respective shoulder strap 14 by two mounting buckles 29 and a 4-way slider buckle 31 disposed between the two mounting buckles 29 on the respective shoulder strap 14. A user can pull the pulls 26 either directly or by pulling on the pull strap 25 to move the lid 16 from the closed position to the open position, and can optionally use the 4-way slider buckle 31 to adjust the pull strap 25 to maintain the lid 16 in the open position if desired. The clip buckles 30 and pull strap 25 are merely one illustrative example, and a wide range of other types of strap and fastener arrangements are also contemplated, including without limitation other types of buckles, magnets, and hook-and-loop fasteners. In the illustrated embodiment, as best seen in FIG. 9, the pulls 26 each have a reinforcement 27 extending between the clip buckle 30 and a point on the lid 16 approximately midway between the distal end 28 and the living hinge 24. Preferably, the pulls 26 and reinforcements 27 are rigid or at least substantially rigid. The pulls 26 and/or pull straps 25 may be of adjustable length to accommodate persons of various shapes and sizes. The pulls 26 may be releasably coupled to the lid 16. Although a plurality of pulls 26 are shown in the illustrated embodiment, other embodiments may have only a single pull, or multiple pulls may be coupled to a single actuator.

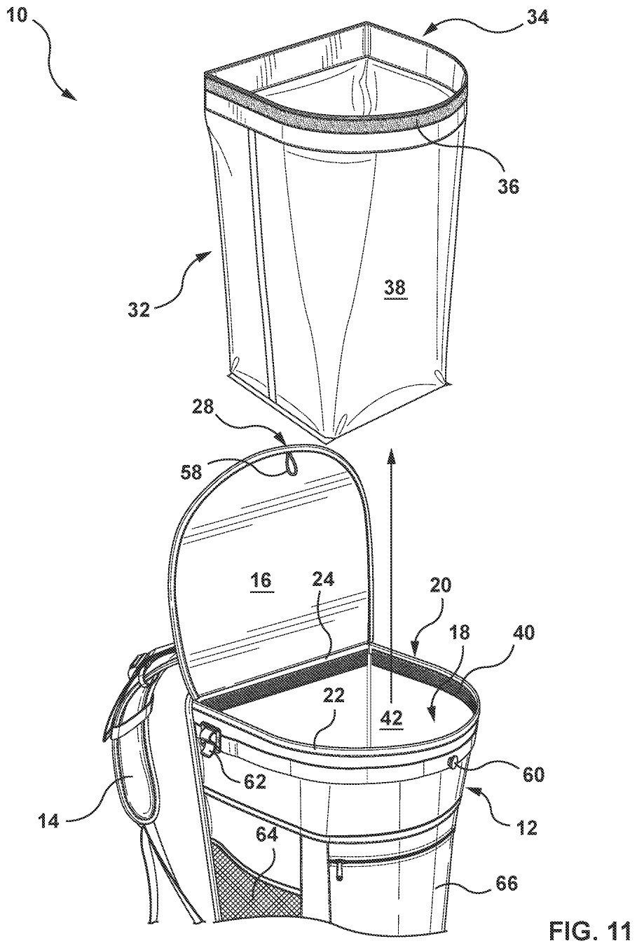

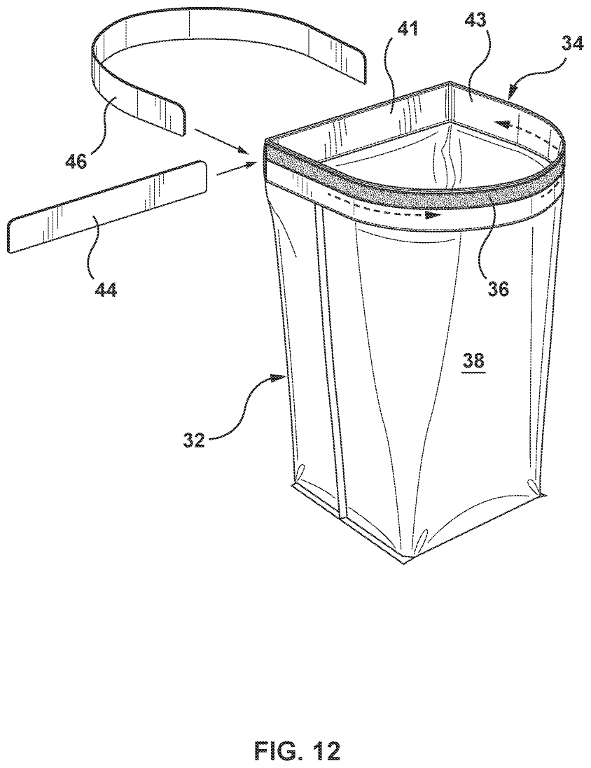

Referring now to FIG. 11, in a preferred embodiment the wearable litter receptacle 10 further comprises a removable liner 32. When installed, a mouth 34 of the liner 32 is disposed within, and in registration with, the opening 20 of the container 12. In the illustrated embodiment both the opening 20 and the mouth 34 are generally D-shaped although other configurations are also contemplated. In the illustrated embodiment, one portion 36 of a hook-and-loop fastener strip extends around the mouth 34 of the removable liner 32 on an exterior surface 38 thereof and the other, mating portion 40 of the hook-and-loop fastener strip extends around the opening 20 of the container 12 on an interior surface 42 thereof. The mating portions 36, 40 of hook-and-loop fastener strip enable releasable securement of the mouth 34 of the liner 32 within the opening 20 of the container 12 and thereby enable releasable securement of the liner 32 inside the container 12. Although shown as continuous mating portions 36, 40 of hook-and-loop fastener strip, intermittent portions of hook-and-loop fastener strip may also be used, as may other suitable types of fastener. In a particularly preferred embodiment, the liner 32 is a washable, reusable liner 32, and may be formed from any suitable material(s), including natural fabrics, synthetic fabrics, blends of natural and synthetic fabrics, or plastic sheet materials, or any combination thereof. As shown in FIG. 12, in a preferred embodiment the mouth 34 of the liner 32 includes sleeves 41, 43 that receive respective straight and curved stiffeners 44, 46 that maintain the shape of the mouth 34. The stiffeners may be formed from any suitable material, including metal or plastic. In some optional embodiments, the substantially rigid frame that extends around and maintains the opening 20 of the container 12 may be provided by the stiffeners 44, 46 rather than by a separate frame formed as part of the container. Although a preferred embodiment provides a washable, reusable liner 32, in other embodiments the liner may be disposable.

As can be seen in FIG. 13, when the wearable litter receptacle 10 is in the closed configuration wherein the lid 16 is in the closed position, the container 12 is closed and any litter disposed within the interior volume 18 is retained therein by the lid 16. Preferably, the lid 16 is biased into the closed position. In the illustrated embodiment, this is achieved by gravity when the wearable receptacle 10 is worn in an upright position, as shown in FIGS. 13 and 14. Other forms of biasing may also be used, for example one or more resilient tethers.

Of note, as can be seen in FIG. 14, when the wearable litter receptacle 10 is worn by the user 50 in the open configuration wherein the lid 16 is in the open position, the lid 16 forms a shield to protect the back 52 of the head 54 of the user 50. Thus, a user can use a trash picker claw to retrieve litter from the ground, and extend the trash picker claw over either shoulder to drop the litter into the interior volume 18 through the opening 20 without fear of any litter striking them in the back of the head. Any such litter will be harmlessly deflected by the lid 16. As noted above, the pulls 26 and reinforcements 27 are preferably rigid or at least substantially rigid; this rigidity allows the pulls 26 and reinforcements 27 to inhibit the lid 16 impacting the back 52 of the head 54 of the user 50, for example where the 4-way slider buckle 31 is used to adjust the pull strap 25 to maintain the lid 16 in the open position. The chevron-shaped arrangement wherein the pulls 26 and reinforcements 27 diverge allows the pulls 26 and reinforcements 27 to bypass the head 54 of the user 50.

Preferably, the container 12 is configured to stand upright on its bottom surface 56 when full. Optionally, the lid 16 may be provided with a loop 58 at the distal end 28 that can be looped around a stud 60 disposed on the container 12 adjacent the opening 20 to maintain the lid 16 in the closed position, for example once the container 12 is full. The container 12 may also be provided with a clasp 62 adapted to secure a litter picker claw when not in use. The container may additionally be provided with compartments, such as mesh pockets 64 and zippered pocket 66, to hold litter collecting accessories such as gloves, tongs and disposable bags. Preferably, the zippered pocket 66 is waterproof or at least substantially water-resistant, including a waterproof or water-resistant zipper, so that it is suitable for personal items. Other items may also be carried in the pockets 64, 66. For example, the mesh pockets 64 may hold reusable water bottles, and the zippered pocket 66 may hold snacks, which may include dog snacks and perhaps a collapsible bowl in case the user is accompanied by a faithful dog whilst collecting litter. Of course, these are merely examples, and a wide array of compartments may be provided, and may contain any number of useful (or other) things. A handle 68 may be affixed to the container 12 between the shoulder straps 14.

Certain currently preferred embodiments have been described by way of example. It will be apparent to persons skilled in the art that a number of variations and modifications can be made without departing from the scope of the claims.

### LIST OF REFERENCE NUMERALS

This list is provided for convenience of reference only, and no limitation is implied:
10 Wearable litter receptacle
12 Container
14 Shoulder straps
16 Lid
18 Interior volume of container
20 Opening of container
22 Frame
24 Living hinge
25 Pull strap
26 Pull
27 Reinforcement
28 Distal end of lid
29 Mounting buckles
30 Quick-release clip buckle
31 4-Way slider buckle
32 Removable liner
34 Mouth of removable liner
36 Portion of hook-and-loop fastener strip (liner)
38 Exterior surface of removable liner
40 Portion of hook-and-loop fastener strip (container)
41 Sleeve (straight)
42 Interior surface of container
43 Sleeve (curved)
44 Straight stiffener
46 Curved stiffener
50 User
52 Back of user's head
54 User's head
56 Bottom surface of container
58 Loop (on lid)
60 Stud (on container)
62 Clasp
64 Mesh pockets
66 Zippered pocket
68 Handle

What is claimed is:

1. A wearable litter receptacle, comprising:
a container defining an interior volume and having a litter-receiving opening that opens into the interior volume;
shoulder straps coupled to the container whereby the receptacle can be worn as a backpack;
a lid, wherein the lid is hinged to the container adjacent the shoulder straps so that the lid can pivot between an open position in which the opening of the container is exposed, and a closed position in which the lid covers and closes the opening;
wherein when the container is worn by a user with the lid in the open position, the lid forms a shield to protect a back of the user's head from refuse directed toward the opening of the container; and
at least one pull coupled to the lid and adapted to move the lid from the closed position to the open position by pulling upon the pull.

2. The wearable litter receptacle of claim 1, wherein the container is a rigid container.

3. The wearable litter receptacle of claim 1, wherein the container is a soft-walled, collapsible container.

4. The wearable litter receptacle of claim 3, wherein a substantially rigid frame extends around and maintains the opening.

5. The wearable litter receptacle of claim 1, further comprising a removable liner.

6. The wearable litter receptacle of claim 5, wherein the liner is a washable, reusable liner.

7. The wearable litter receptacle of claim 5, wherein the liner is a disposable liner.

8. The wearable litter receptacle of claim 1, further comprising at least one fastener adapted to couple the respective pull to at least one of the shoulder straps to maintain the lid in the open position.

9. The wearable litter receptacle of claim 8, wherein each pull is of adjustable length.

10. The receptacle of claim 1, wherein the lid is hinged to the container by a living hinge.

11. The receptacle of claim 1, wherein the lid is substantially rigid.

12. The receptacle of claim 1, wherein the lid is a soft-walled lid whose shape is maintained by a substantially rigid support.

13. The receptacle of claim 1, wherein the at least one pull comprises two pulls in a chevron-shaped arrangement.
